(19) United States
(12) Patent Application Publication
(10) Pub. No.: US 2016/0182485 A1
(43) Pub. Date: Jun. 23, 2016

(54) METHOD AND DEVICE FOR CONTROLLING WEB PAGE TO INVOKE SYSTEM FUNCTION, AND STORAGE MEDIUM THEREOF

(71) Applicant: Hisense Electric Co., Ltd., Qingdao (CN)

(72) Inventors: Yongjian ZHAO, Qingdao (CN); Cheng YANG, Qingdao (CN); Kai LIU, Qingdao (CN)

(21) Appl. No.: 14/789,013

(22) Filed: Jul. 1, 2015

(30) Foreign Application Priority Data
Dec. 17, 2014 (CN) 201410785141.9

(51) Int. Cl. H04L 29/06; H04W 88/02; G06F 17/27; H04L 29/08

(52) U.S. Cl. CPC H04L 63/083; H04L 67/02; H04W 88/02; G06F 17/2705

(57) ABSTRACT

The disclosure discloses a method and device for controlling a web page to invoke a system function, and storage medium thereof. the method includes: parsing, by a browser in the intelligent device, a web page for an authorization code in the web page, and a privilege code of a system function requested to be invoked; obtaining, by the browser, a system function invoking privilege corresponding to the web page according to the authorization code, wherein the system function invoking privilege includes a list of privilege codes of system functions allowed to be used by the web page; and If the browser determines that the privilege code of the system function requested to be invoked belongs to the list of privilege codes in the system function invoking privilege, then invoking the system function requested to be invoked through an interface function of the corresponding system function to support running of the web page; otherwise, prohibiting invoking of the interface function of the system function requested to be invoked.

### CROSS-REFERENCE TO RELATED APPLICATION

This application claims the benefit and priority of Chinese Patent Application No. 201410785141.9 filed Dec. 17, 2014. The entire disclosure of the above application is incorporated herein by reference.

### FIELD

The present disclosure relates to the field of communications and particularly to a method and device for controlling a web page to invoke a system function, and storage medium thereof.

### BACKGROUND

This section provides background information related to the present disclosure which is not necessarily prior art.

At present, an increasing number of intelligent devices download and install applications through web pages being run, and the applications developed based upon the web technology (e.g., the Hyper-Text Markup Language (HTML), the JavaScript (simply the JS), the CSS, etc.) are run through a browser and distinguished by their across-platform characteristic. The browser operating in the intelligent device provides an interface to a local function for use by an upper web page.

In view of security, a system function of the intelligent device may not be invoked directly by the HTML, the JavaScript and other interpretative languages which are dynamic, and in order to enable a system function of the intelligent device to be invoked by a web page, the intelligent device provides the system function to be invoked, in the form of a JavaScript object to be invoked by the web page, that is, some system function of the intelligent device may be used by the web page simply by invoking a specified method in the specific JavaScript object.

### SUMMARY

This section provides a general summary of the disclosure, and is not a comprehensive disclosure of its full scope or all of its features.

In one aspect, some embodiments of the disclosure provide a method for controlling a web page to invoke a system function, the method including:

parsing, by a browser in the intelligent device, a web page for an authorization code in the web page, and a privilege code of a system function requested to be invoked;

obtaining, by the browser, a system function invoking privilege corresponding to the web page according to the authorization code, wherein the system function invoking privilege includes a list of privilege codes of system functions allowed to be used by the web page; and

If the browser determines that the privilege code of the system function requested to be invoked belongs to the list of privilege codes in the system function invoking privilege, then invoking the system function requested to be invoked through an interface function of the corresponding system function to support running of the web page; if the browser determines that the privilege code of the system function requested to be invoked does not belong to the list of privilege codes in the system function invoking privilege, prohibiting invoking of the interface function of the system function requested to be invoked.

In another aspect, some embodiments of the disclosure provide a device for controlling a web page to invoke a system function, the device including a memory and one or more processors, wherein the memory stores one or more computer readable program codes, and the one or more processors is or are configured to perform the one or more computer readable program codes:

to parse a web page for an authorization code in the web page, and a privilege code of a system function requested to be invoked;

to obtain a system function invoking privilege corresponding to the web page according to the authorization code, wherein the system function invoking privilege includes a list of privilege codes of system functions allowed to be used by the web page; and

if it is determined that the privilege code of the system function requested to be invoked belongs to the list of privilege codes in the system function invoking privilege, to invoke the system function requested to be invoked through an interface function of the corresponding system function to support running of the web page; if it is determined that the privilege code of the system function requested to be invoked does not belong to the list of privilege codes in the system function invoking privilege, to prohibit invoking of the interface function of the system function requested to be invoked.

In a further aspect, some embodiments of the disclosure provide a computer readable storage medium storing thereon instruction codes which, upon being executed, may perform the operations of:

parsing, by a browser in an intelligent device, a web page for an authorization code in the web page, and a privilege code of a system function requested to be invoked;

obtaining, by the browser, a system function invoking privilege corresponding to the web page according to the authorization code, wherein the system function invoking privilege includes a list of privilege codes of system functions allowed to be used by the web page; and

If the browser determines that the privilege code of the system function requested to be invoked belongs to the list of privilege codes in the system function invoking privilege, then invoking the system function requested to be invoked through an interface function of the corresponding system function to support running of the web page; if the browser determines that the privilege code of the system function requested to be invoked does not belong to the list of privilege codes in the system function invoking privilege, prohibiting invoking of the interface function of the system function requested to be invoked.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a schematic flow chart of a method for controlling a web page to invoke a system function according to some embodiments of the disclosure;

FIG. 2 illustrates a schematic flow chart of the entire method for controlling a web page to invoke a system function according to some embodiments of the disclosure;

FIG. 3 illustrates a schematic structural diagram of a device for controlling a web page to invoke a system function according to some embodiments of the disclosure; and

FIG. 4 illustrates a schematic structural diagram of a terminal according to some embodiments of the disclosure.

### DETAILED DESCRIPTION

Example embodiments will now be described more fully with reference to the accompanying drawings.

There is an open characteristic of a web page, and if a system function of an intelligent device may be invoked by any web page with any restriction, then the performance and the security of the intelligent device may be degraded. Thus invoking of a system function of the intelligent device needs to be constrained and supervised, and there are generally the following two supervision schemes at present:

Firstly a list of Uniform Resource Locators (URLs) is hardened in the intelligent device, and before a system function is allowed to be invoked by a web page, the intelligent device determines whether a URL of the web page belongs to the list of URLs, and if not, then the system function is prohibited from being invoked by the web page. In this scheme, the list of URLs which has been firmed in the intelligent device before the intelligent device leave the factory may not be adjusted flexibly.

Secondly a web page is packaged into a web application with a configuration file including indicators of system functions to be invoked, and the intelligent device running the web application extracts the indicators and generates a privilege tree of the web application from the indicators so that each branch of the privilege tree represents particular one of the system functions, and when a system function needs to be invoked by the web application, the intelligent device determines whether there is such a privilege in the privilege tree that corresponds to the system function, and if so, then the system function is allowed to be invoked; otherwise, the system function is prohibited from being invoked. In this scheme, the web page needs to be packaged into the web application under a specific rule, and the configuration file needs to be set for each web page, which may contradict the development trend of the web applications becoming light-weighted, and the diversity of states in which they appear.

In order to address the technical problem above, some embodiments of the disclosure provide at least one method and device in an intelligent device for controlling a web page to invoke a system function so as to control flexibly the web page to invoke the system function without setting a configuration file for the web page. In these embodiments, a browser in the intelligent device parses a web page for an authorization code, and a privilege code of a system function requested to be invoked, in the web page, obtains a system function invoking privilege of the web page according to the authorization code, determines that the privilege code of the system function requested to be invoked by the web page belongs to the list of privilege codes in the system function invoking privilege, and invokes the system function requested to be invoked by the web page through an interface function of the corresponding system function, so that the browser may determine the system function invoking privilege of the web page simply by obtaining the authorization code of the web page without setting a configuration file for the web page or packaging the web page, and may control flexibly the web page to invoke the system function, by adjusting the authorization code or the system function invoking privilege corresponding to the authorization code.

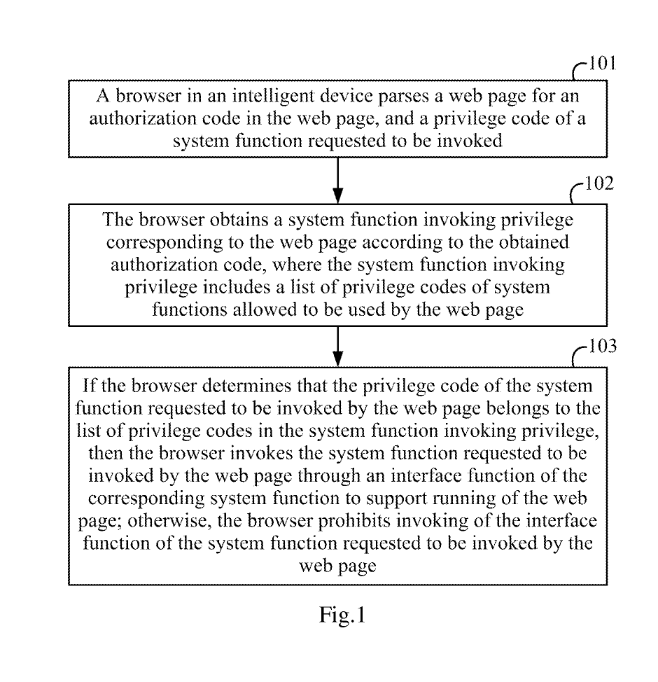

In some embodiments of the disclosure, as illustrated in FIG. 1, a flow of a method for controlling a web page to invoke a system function may be as follows:

Operation 101: A browser in an intelligent device parses a web page for an authorization code in the web page, and a privilege code of a system function requested to be invoked.

In some embodiments of the disclosure, a privilege code is preset for each system function in the intelligent device, and the privilege code of the system function may identify uniquely a system function invoking privilege. Different system functions correspond to different privilege codes. In some embodiments, each system function corresponds to a JS object, that is, one privilege code corresponds to one JS object. The intelligent device takes the authorization code of the web page as an input parameter to invoke the JS object corresponding to the system function so as to create a JS object instance, which functions as an interface function, and to invoke the system function through the JS object instance.

Here the web page may be run online or offline.

In some embodiment of the disclosure, the authorization code of the web page may be formed as follows:

A cloud server obtains information about the web page, and information about the system function of the intelligent device requested by a developer of the web page to be invoked, and generates authorization information of the web page, and the authorization code of the web page; and the cloud server stores the authorization code of the web page, and the authorization information of the web page, and transmits the authorization code to the web page.

In some embodiments, the information about the web page includes at least an identifier of the web page. The authorization information of the web page may include at least the information about the web page, and the system function invoking privilege and additionally a generation time, a validity period of time, and a scrambler, of the authorization code, and the system function invoking privilege includes a list of privilege codes of system functions allowed to be used by the web page.

Operation 102: The browser obtains a system function invoking privilege corresponding to the web page according to the obtained authorization code, where the system function invoking privilege includes a list of privilege codes of system functions allowed to be used by the web page.

Optionally if the browser in the intelligent device may access the cloud server, then the authorization code may include only the identifier of the web page so that the browser in the intelligent device obtains authorization information of the web page from the cloud server according to the authorization code.

In this embodiment, the browser in the intelligent device may determine whether there is a system function invoking privilege corresponding to the authorization code, according to a correspondence relationship in a memory of the intelligent device, between the authorization code and the system function invoking privilege, and if so, then the browser obtains the system function invoking privilege corresponding to the authorization code, and determines the obtained system function invoking privilege as the system function invoking privilege corresponding to the web page; and

If not, then the browser in the intelligent device may transmit the authorization code to the cloud server, and the cloud server may obtain and return to the browser a system function invoking privilege corresponding to the authorization code according to the authorization code, and the browser in the intelligent device may receive the system function invoking privilege returned by the cloud server, determine the received system function invoking privilege as the system function invoking privilege corresponding to the web page, and store a correspondence relationship between the system function invoking privilege of the web page and the identifier of the web page in the memory.

In some embodiments, the authorization code further includes a system function invoking privilege corresponding to the web page in addition to the identifier of the web page.

In some embodiment of the disclosure, if the browser in the intelligent device has not received the system function invoking privilege of the web page returned by the cloud server in a preset length of time after transmitting the authorization code of the web page to the cloud server, then the browser may parse the authorization code to obtain the system function invoking privilege carried in the authorization code, and determine the obtained system function invoking privilege as the system function invoking privilege corresponding to the web page.

in some embodiments, the authorization code further includes information about the web page in addition to the identifier of the web page.

In some embodiment of the disclosure, if the cloud server determines the information about the web page carried in the authorization code of the web page is the same as locally stored information about the web page corresponding to the identifier of the web page, then the cloud server may return the system function invoking privilege of the web page to the intelligent device.

If the cloud server determines the information about the web page carried in the authorization code of the web page is not the same as the locally stored information about the web page corresponding to the identifier of the web page, then the cloud server returns an error to the intelligent device; and if the browser in the intelligent device receives the error returned by the cloud server, then the browser may reject the web page for invoking the requested system function.

Operation 103: If the browser determines that the privilege code of the system function requested to be invoked by the web page belongs to the list of privilege codes in the system function invoking privilege, then the browser invokes the system function requested to be invoked by the web page through an interface function of the corresponding system function to support running of the web page; otherwise, the browser prohibits invoking of the interface function of the system function requested to be invoked by the web page.

in some embodiments, in the intelligent device, a privilege code may be set for each system function allowed to be invoked by the web page so that different system functions may correspond to different privilege codes.

In some embodiment of the disclosure, the intelligent device may categorize the system functions allowed to be invoked by the web page, and set a first privilege code for each category so that different first privilege codes may be set for different categories, and set a second privilege code for each system function in each category so that different second privilege codes may be set for different system functions of the same category.

Here if the privilege code, obtained by the browser in the intelligent device, of the system function requested to be invoked by the web page is a first privilege code, then the browser invoke the interface function of the system function upon determining that the first privilege code is included among the system function privileges of the web page; and if the privilege code, obtained by the browser in the intelligent device, of the system function requested to be invoked by the web page is a second privilege code, then the browser invoke the interface function of the system function upon determining that the second privilege code, or the first privilege code, to which the second privilege is subordinated, is included among the system function privileges of the web page.

In some embodiment of the disclosure, the interface function of the system function may be a JS object or a JS method.

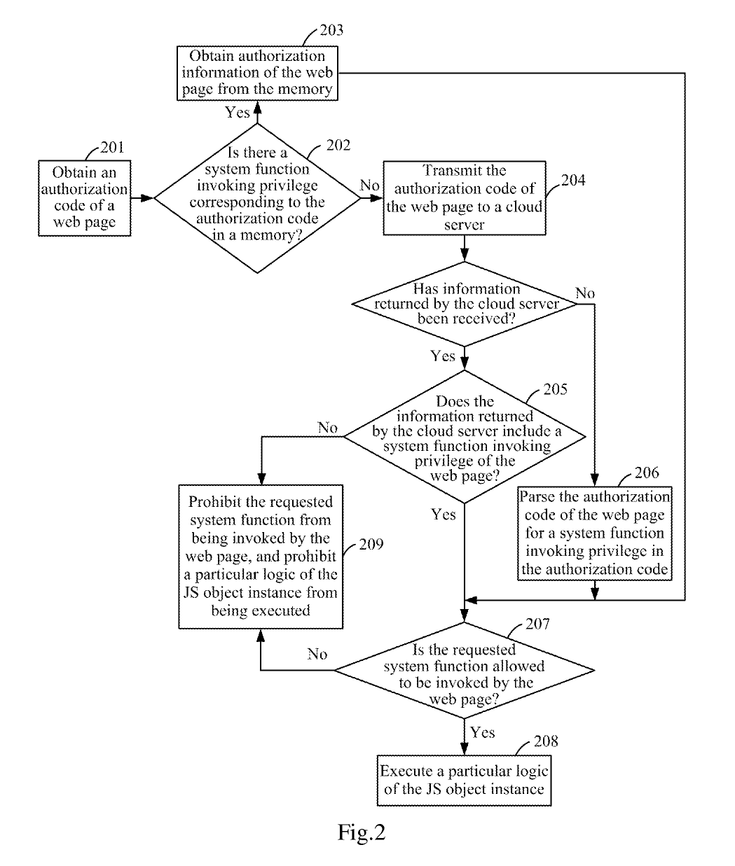

A process of controlling a web page to invoke a system function will be described below in an embodiment thereof with reference to FIG. 2.

Operation 201: A JS object is preset for each system function in an intelligent device, and a browser in the intelligent device obtains an authorization code of the web page including at least the identifier of the web page, takes the authorization code as an input parameter of the JS object corresponding to the system function requested to be invoked, and creates an JS object instance corresponding to an interface function of the system function requested to be invoked by the web page, and the authorization code at least includes the identifier of the web page;

Operation 202: The browser in the intelligent device searches a memory according to the authorization code of the web page for a system function invoking privilege corresponding to the authorization code, and if it is found, then the process proceeds to the operation 203; otherwise, the process proceeds to the operation 204;

Operation 203: The browser in the intelligent device obtains the system function invoking privilege of the web page from the memory, and the process proceeds to the operation 207;

Operation 204: The browser in the intelligent device transmits the authorization code of the web page to a cloud server, and if the browser receives information returned by the cloud server, then the process proceeds to the operation 205; otherwise, the process proceeds to the operation 206;

Operation 205: The browser in the intelligent device determines whether the information returned by the cloud server includes a system function invoking privilege of the web page, and if so, then the process proceeds to the operation 207; otherwise, the process proceeds to the operation 209;

Operation 206: The browser in the intelligent device parses the authorization code of the web page for a system function invoking privilege in the authorization code, and the process proceeds to the operation 207;

Operation 207: The browser in the intelligent device determines whether the requested system information is allowed by the obtained system function invoking privilege to be invoked by the web page, and if so, then the process proceeds to the operation 208; otherwise, the process proceeds to the operation 209;

Operation 208: The browser in the intelligent device executes a particular logic of the JS object instance; and

Operation 209: The browser in the intelligent device prohibits the requested system function from being invoked by the web page, and prohibits a particular logic of the JS object instance from being executed.

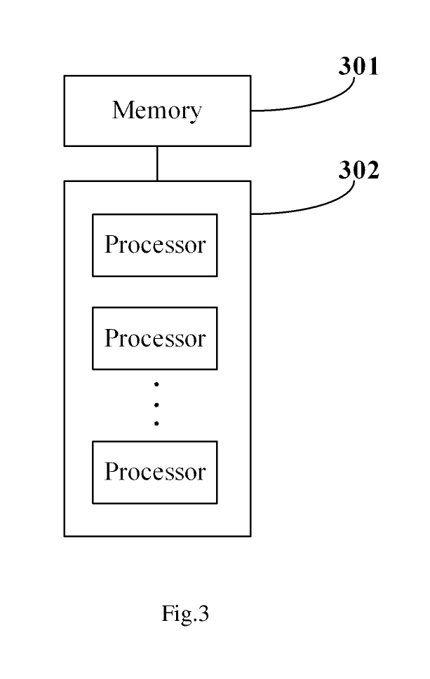

Based upon the similar idea, some embodiments of the disclosure further provide a device in an intelligent device for controlling a system function to be invoked for a web page, and the device may perform the method for controlling a system function to be invoked for a web page in some of the embodiment above of the disclosure, so a repeated description thereof will be omitted here. As illustrated in FIG. 3, in some embodiments, the device includes a memory 301 and one or more processors 302, where the memory 301 stores one or more computer readable program codes, and the one or more processors 302 is or are configured to perform the one or more computer readable program codes:

To parse a web page for an authorization code in the web page, and a privilege code of a system function requested to be invoked;

To obtain a system function invoking privilege corresponding to the web page according to the authorization code, where the system function invoking privilege includes a list of privilege codes of system functions allowed to be used by the web page; and

If it is determined that the privilege code of the system function requested to be invoked belongs to the list of privilege codes in the system function invoking privilege, to invoke the system function requested to be invoked through an interface function of the corresponding system function to support running of the web page; otherwise, to prohibit invoking of the interface function of the system function requested to be invoked.

Optionally the authorization code includes at least the identifier of the web page; and

Obtaining the system function invoking privilege corresponding to the web page according to the authorization code includes:

Determining whether there is a system function invoking privilege corresponding to the obtained authorization code, according to a correspondence relationship in a memory of the intelligent device, between the authorization code and the system function invoking privilege, and if so, then obtaining the system function invoking privilege corresponding to the authorization code, and determining the obtained system function invoking privilege as the system function invoking privilege corresponding to the web page; and

If not, then transmitting the authorization code to a cloud server, receiving the system function invoking privilege returned by the cloud server, and determining the received system function invoking privilege as the system function invoking privilege corresponding to the web page.

Optionally the authorization code may further include a system function invoking privilege corresponding to the web page; and

After the authorization code is transmitted to the cloud server, the one or more processors 302 may be further configured to perform the one or more computer readable program codes:

If the system function invoking privilege of the web page returned by the cloud server does not been received in a preset length of time, to parse the authorization code to obtain the system function invoking privilege carried in the authorization code, and to determine the obtained system function invoking privilege as the system function invoking privilege corresponding to the web page.

Optionally the authorization code may further include information about the web page; and

Before the system function invoking privilege returned by the cloud server is received, the cloud server obtains and returns the system function invoking privilege corresponding to the authorization code according to the authorization code upon determining that the information about the web page carried in the authorization code is the same as locally stored information about the web page corresponding to the identifier of the web page.

Optionally the authorization code in the web page and the system function invoking privilege corresponding to the web page may be generated by a cloud server according to information about the web page.

Based upon the technical solutions above, in some of the embodiments of the disclosure, the browser in the intelligent device parses a web page for an authorization code, and a privilege code of a system function requested to be invoked, in the web page, obtains a system function invoking privilege of the web page according to the authorization code, determines that the privilege code of the system function requested to be invoked by the web page belongs to the list of privilege codes in the system function invoking privilege, and invokes the system function requested to be invoked by the web page through an interface function of the corresponding system function, so that the browser may determine the system function invoking privilege of the web page simply by obtaining the authorization code of the web page without setting a configuration file for the web page or packaging the web page, and may control flexibly the web page to invoke the system function, by adjusting the authorization code or the system function invoking privilege corresponding to the authorization code.

Moreover in some embodiments of the disclosure, the system function invoking privilege of the web page is stored in the cloud server so that the system function invoking privilege of the web page may be managed centrally, and if there is a change to the system function invoking privilege of the web page, then the system function invoking privilege corresponding to the web page may be updated in a timely manner. For example, if the web page is attacked, then the cloud server may set the system function invoking privilege corresponding to the web page as being prohibited from invoking any system function.

Moreover the intelligent device may parse the authorization code to obtain the system function invoking privilege of the web page so that the intelligent device may obtain the system function invoking privilege of the web page even if there is no network available.

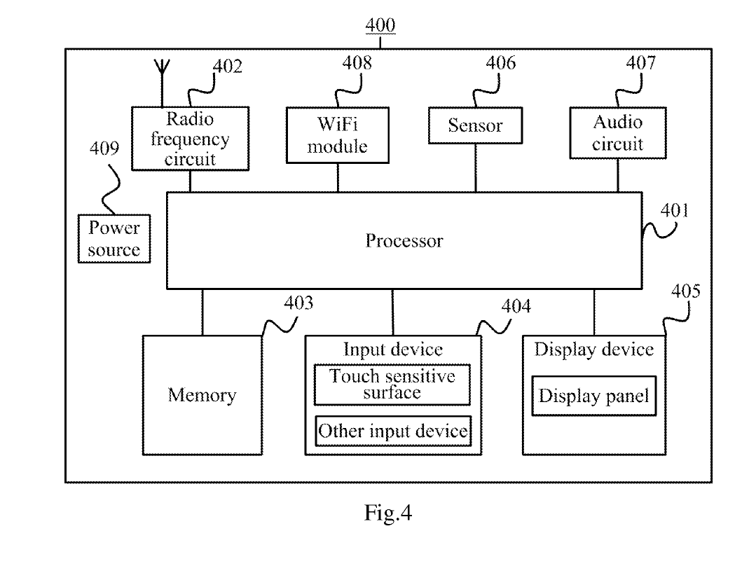

As illustrated in FIG. 4, some embodiments of the disclosure further provide a terminal 400, which may be any of various handheld devices (e.g., a handset, a tablet computer, a PDA, etc.), and which may include a processor 401 including one or more processing cores, a radio frequency circuit 402, a memory 403 including one or more computer readable storage mediums, an input device 404, a display device 405, a sensor 406, an audio circuit 407, a WiFi module 408, a power source 409 and other components. Those skilled in the art may appreciate that the structure of the terminal 400 in this embodiment will not be intended to be limiting, but more or less components may be included or some of the components may be combined or the components may be arranged differently, where:

The radio frequency circuit 402 may be configured to receive and transmit a signal in the course of receiving and transmitting information or in communication, particularly by transferring downlink information of a base station to the one or more processors 401 for processing upon reception of the downlink information; and also by transmitting related uplink data to the base station. Typically the radio frequency circuit 402 includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the radio frequency circuit 402 may further communicate with a network and another device through wireless communication. The wireless communication may comply with any of communication standards or protocols including but not limited to the GSM (Global System of Mobile communication), the GPRS (General Packet Radio Service), the CDMA (Code Division Multiple Access), the WCDMA (Wideband Code Division Multiple Access), the LTE (Long Term Evolution), an e-mail, the SMS (Short Messaging Service), etc.

The memory 403 may be configured to store software programs and modules, and the processor or processors 401 is or are configured to run the software programs and the modules stored in the memory 403 to thereby perform various function applications and data processing. The memory 403 may generally include a program storage area and a data storage area, where an operating system, applications required for at least one function (e.g., an audio playing function, an image playing function, etc.), etc., may be stored in the program storage area; and data created for use of the terminal 400 (e.g., audio data, an address book etc.), etc., may be stored in the data storage area. Moreover the memory 403 may include a high-speed random access memory and may further include a nonvolatile memory, e.g., at least one magnetic-disk memory device, a flash memory device or another volatile solid memory device. Correspondingly the memory 403 may further include a memory controller configured to provide an access of the processor or the processors and the input device to the memory.

The input device 404 may be configured to receive input digital or character information and to generate a keyboard, mouse, joystick, optical or track ball signal input related to user setting and function control. Particularly the input device 404 may include a touch sensitive surface and another input device. The touch sensitive surface, also referred to as a touch display screen or a touch pad, may be configured to collect a touch operation by a user thereon or in proximity thereto (e.g., an operation by the user on or in proximity to the touch sensitive surface using his or her finger, a stylus or any other appropriate object or attachment) and to drive a corresponding connected device by preset program. Optionally the touch sensitive surface may include two components which are a touch detection device and a touch controller, where the touch detection device detects the position of touching by the user and detects a signal as a result of the touch operation and transfers the signal to the touch controller; and the touch controller receives the touch signal from the touch detection device and converts it into coordinates of a touch point and further transfers them to the processor or processors 401 and may receive and execute a command sent by the processor or processors 401. Moreover the touch sensitive surface may be embodied in various types of resistive, capacitive, infrared, surface sound wave and other types. The input device 404 may further include another input device in addition to the touch sensitive surface. Particularly the other input device may include but will not be limited to one or more of a physical keyboard, functional keys (e.g., volume control press keys, a power-on or-off press key, etc.), a track ball, a mouse, a joystick, etc.

The display device 405 may be configured to display information input by the user or information provided to the user and various graphic user interfaces of the terminal 400, where these graphic user interfaces may be composed of graphics, texts, icons, videos and any combination thereof. The display device 405 may include a display panel which may be optionally configured in the form of a Liquid Crystal Display (LCD), an Organic Light-Emitting Diode (OLED) display, etc. Furthermore the touch sensitive surface may overlie the display panel, and the touch sensitive surface, upon detection of the touch operation thereon or in proximity thereto, transfers it to the processor or processors 401 to determine the type of the touch event, and thereafter the processor or processors 401 provides or provide a corresponding visual output on the display panel according to the type of the touch event. Although the touch sensitive surface and the display device are embodied in this embodiment as two separate components to perform the input and output functions, the touch sensitive surface and the display device may be integrated to perform the input and output functions in some embodiments.

The terminal 400 may further include at least one sensor 406, e.g., an optical sensor, a motion sensor and other sensors. Particularly the optical sensor may include an ambient optical sensor and a proximity sensor, where the ambient optical sensor may adjust the brightness of the display panel according to the luminosity of ambient light rays, and the proximity sensor may power off the display panel and/or a backlight when the terminal 400 moves nearby an ear. A gravity acceleration sensor which is a motion sensor may detect the magnitudes of accelerations in respective directions (typically three axes) and may detect the magnitude and the direction of gravity when the sensor is stationary and may be configured to perform applications of identifying the posture of a handset (e.g., switching between landscape and portrait modes, relevant games, calibration of the posture of a magnetometer, etc.), a relevant function of identifying vibration (e.g., a pedometer, a knock, etc.), etc.; and the terminal 400 may be further configured with a gyroscope, a barometer, a hygrometer, a thermometer, an infrared sensor and other sensors, and a repeated description of these components will be omitted here.

The audio circuit 407, a speaker and a transducer may provide an audio interface between the user and the terminal 400. The audio circuit 407 may convert received audio data into an electric signal and transmit the electric signal to the speaker, which is converted by the speaker into an audio signal for output; and on the other hand, the transducer converts a collected audio signal into an electric signal which is received by the audio circuit 407 and then converted into audio data, and the audio data is further output to the processor or processors 401 for processing and then transmitted to another apparatus through the radio frequency circuit, for example, or the audio data is output to the memory 403 for further processing. The audio circuit 407 may further include an earphone jack for communication between a peripheral earphone and the terminal 400.

The WiFi falls into the category of short-range wireless transmission technologies, and the terminal 400 may assist the user in receiving and transmitting an e-mail, browsing a webpage, accessing streaming media, etc., through the WiFi module 408 by which the user is provided with a wireless access to the broadband Internet. Although the WiFi module 408 is illustrated in this embodiment, it may be appreciated that it may not be necessarily required for the terminal 400 but may be omitted as desired without departing from the scope of the disclosure.

The processor or processors 401 is or are a control component of the terminal 400, has the respective components connected by various interfaces and lines, and runs or executes the software programs and/or modules stored in the memory and invokes the data stored in the memory to perform the various functions of the terminal 400 and to process the data to thereby manage and control the handset as a whole. Optionally the processor or processors 401 may include one or more processing cores; and preferably the processor or processors 401 may be integrated with an application processor and a modem processor, where the application processor generally handles the operating system, the user interfaces, the applications, etc., and the modem processor generally handles wireless communication. As may be appreciated, the modem processor above may not be integrated into the processor or processors 401.

The terminal 400 further includes a power source 409 (e.g., a battery) powering the respective components, and preferably the power source 409 may be logically connected with the processor or processors 401 through a power management system to thereby perform charging and discharging management, power consumption management, etc., through the power management system. The power source 409 may further include one or more DC or AC power sources, recharging systems, power source failure detection circuits, power source transformers or inverters, power source status indicators and any other components.

Although not illustrated, the terminal 400 may further include a camera, a Bluetooth module, etc., and a repeated description thereof will be omitted here. Particularly in this embodiment, the display device 405 of the terminal 400 is a touch screen display, and the terminal 400 further includes the memory 403 in which one or more programs are stored and configured to be executed by the one or more processors 401.

Based upon the technical solutions above, in some of the embodiments of the disclosure, the browser in the intelligent device 400 parses a web page for an authorization code, and a privilege code of a system function requested to be invoked, in the web page, obtains a system function invoking privilege of the web page according to the authorization code, determines that the privilege code of the system function requested to be invoked by the web page belongs to the list of privilege codes in the system function invoking privilege, and invokes the system function requested to be invoked by the web page through an interface function of the corresponding system function, so that the browser may determine the system function invoking privilege of the web page simply by obtaining the authorization code of the web page without setting a configuration file for the web page or packaging the web page, and may control flexibly the web page to invoke the system function, by adjusting the authorization code or the system function invoking privilege corresponding to the authorization code.

Some embodiments of the disclosure further provide a computer readable storage medium storing thereon instruction codes which, upon being executed, may perform the operations of:

Parsing, by a browser in an intelligent device, a web page for an authorization code in the web page, and a privilege code of a system function requested to be invoked;

Obtaining, by the browser, a system function invoking privilege corresponding to the web page according to the authorization code, where the system function invoking privilege includes a list of privilege codes of system functions allowed to be used by the web page; and

If the browser determines that the privilege code of the system function requested to be invoked belongs to the list of privilege codes in the system function invoking privilege, then invoking the system function requested to be invoked through an interface function of the corresponding system function to support running of the web page; otherwise, prohibiting invoking of the interface function of the system function requested to be invoked.

Optionally the authorization code includes at least the identifier of the web page; and

Obtaining, by the browser, the system function invoking privilege corresponding to the web page according to the authorization code includes:

Determining whether there is a system function invoking privilege corresponding to the obtained authorization code, according to a correspondence relationship in a memory of the intelligent device, between the authorization code and the system function invoking privilege, and if so, then obtaining the system function invoking privilege corresponding to the authorization code, and determining the obtained system function invoking privilege as the system function invoking privilege corresponding to the web page; and

If not, then transmitting the authorization code to a cloud server, receiving the system function invoking privilege returned by the cloud server, and determining the received system function invoking privilege as the system function invoking privilege corresponding to the web page.

Optionally the authorization code may further include a system function invoking privilege corresponding to the web page; and

After the browser transmits the authorization code to the cloud server, if the browser does not receive the system function invoking privilege returned by the cloud server in a preset length of time, then parsing the authorization code to obtain the system function invoking privilege carried in the authorization code, and determining the obtained system function invoking privilege as the system function invoking privilege corresponding to the web page.

Optionally the authorization code may further include information about the web page; and

Before the browser receives the system function invoking privilege returned by the cloud server, the cloud server obtains and returns the system function invoking privilege corresponding to the authorization code according to the authorization code upon determining that the information about the web page carried in the authorization code is the same as locally stored information about the web page corresponding to the identifier of the web page.

Optionally the authorization code in the web page and the system function invoking privilege corresponding to the web page may be generated by a cloud server according to information about the web page.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method in an intelligent device for controlling a web page to invoke a system function, the method comprising:
parsing, by a browser in the intelligent device, a web page for an authorization code in the web page, and a privilege code of a system function requested to be invoked;
obtaining, by the browser, a system function invoking privilege corresponding to the web page according to the authorization code, wherein the system function invoking privilege comprises a list of privilege codes of system functions allowed to be used by the web page; and
If the browser determines that the privilege code of the system function requested to be invoked belongs to the list of privilege codes in the system function invoking privilege, then invoking the system function requested to be invoked through an interface function of the corresponding system function to support running of the web page; if the browser determines that the privilege code of the system function requested to be invoked does not belong to the list of privilege codes in the system function invoking privilege, prohibiting invoking of the interface function of the system function requested to be invoked.

2. The method of claim 1, wherein the authorization code comprises at least an identifier of the web page; and
obtaining, by the browser, the system function invoking privilege corresponding to the web page according to the authorization code comprises:
determining whether there is a system function invoking privilege corresponding to the authorization code, according to a correspondence relationship, in a memory of the intelligent device, between the authorization code and the system function invoking privilege, and if there is the system function invoking privilege corresponding to the authorization code, then obtaining the system function invoking privilege corresponding to the authorization code, and determining the obtained system function invoking privilege as the system function invoking privilege corresponding to the web page; and
If there is no system function invoking privilege corresponding to the obtained authorization code, then transmitting, by the browser, the authorization code to a cloud server, and receiving, by the browser, the system function invoking privilege returned by the cloud server, determining the received system function invoking privilege as the system function invoking privilege corresponding to the web page, and storing the system function invoking privilege in the memory of the intelligent device.

3. The method of claim 2, wherein the authorization code further comprise the system function invoking privilege corresponding to the web page; and
after the browser transmits the authorization code to the cloud server, the method further comprises:
if the browser does not receive the system function invoking privilege returned by the cloud server in a preset length of time, then parsing the authorization code to obtain the system function invoking privilege carried in the authorization code, and determining the obtained system function invoking privilege as the system function invoking privilege corresponding to the web page.

4. The method of claim 2, wherein the authorization code further comprises information about the web page; and
before the browser receives the system function invoking privilege returned by the cloud server, the cloud server obtains and returns to the browser the system function invoking privilege corresponding to the authorization code according to the authorization code upon determining that the information about the web page carried in the authorization code is same as locally stored information about the web page corresponding to the identifier of the web page.

5. The method of claim 1, wherein the authorization code in the web page and the system function invoking privilege corresponding to the web page are generated by a cloud server according to information about the web page.

6. A device in an intelligent device for controlling a web page to invoke a system function, the device comprising a memory and one or more processors, wherein the memory stores one or more computer readable program codes, and the one or more processors is or are configured to perform the one or more computer readable program codes:
to parse a web page for an authorization code in the web page, and a privilege code of a system function requested to be invoked;
to obtain a system function invoking privilege corresponding to the web page according to the authorization code, wherein the system function invoking privilege comprises a list of privilege codes of system functions allowed to be used by the web page; and
if it is determined that the privilege code of the system function requested to be invoked belongs to the list of privilege codes in the system function invoking privilege, to invoke the system function requested to be invoked through an interface function of the corresponding system function to support running of the web page; if it is determined that the privilege code of the system function requested to be invoked does not belong to the list of privilege codes in the system function invoking privilege, to prohibit invoking of the interface function of the system function requested to be invoked.

7. The device of claim 6, wherein the authorization code comprises at least an identifier of the web page; and
obtaining the system function invoking privilege corresponding to the web page according to the authorization code comprises:
determining whether there is a system function invoking privilege corresponding to the authorization code, according to a correspondence relationship in a memory of the intelligent device, between the authorization code and the system function invoking privilege, and if there is the system function invoking privilege corresponding to the authorization code, then obtaining the system function invoking privilege corresponding to the authorization code, and determining the obtained system function invoking privilege as the system function invoking privilege corresponding to the web page; and
If there is no system function invoking privilege corresponding to the obtained authorization code, then transmitting the authorization code to a cloud server, receiving the system function invoking privilege returned by the cloud server, determining the received system function invoking privilege as the system function invoking privilege corresponding to the web page, and storing the system function invoking privilege in the memory of the intelligent device.

8. The device of claim 7, wherein the authorization code further comprise the system function invoking privilege corresponding to the web page; and
after the authorization code is transmitted to the cloud server, the one or more processors is or are further configured to perform the one or more computer readable program codes:
if the system function invoking privilege returned by the cloud server does not been received in a preset length of time, to parse the authorization code to obtain the system function invoking privilege carried in the authorization code, and to determine the obtained system function invoking privilege as the system function invoking privilege corresponding to the web page.

9. The device of claim 7, wherein the authorization code further comprises information about the web page; and
before the system function invoking privilege returned by the cloud server is received, the cloud server obtains and returns to the device the system function invoking privilege corresponding to the authorization code according to the authorization code upon determining that the information about the web page carried in the authorization code is same as locally stored information about the web page corresponding to the identifier of the web page.

10. The device of claim 6, wherein the authorization code in the web page and the system function invoking privilege corresponding to the web page are generated by a cloud server according to information about the web page.

11. A computer readable storage medium, storing thereon instruction codes which, upon being executed, may perform the operations of:
parsing, by a browser in an intelligent device, a web page for an authorization code in the web page, and a privilege code of a system function requested to be invoked;
obtaining, by the browser, a system function invoking privilege corresponding to the web page according to the authorization code, wherein the system function invoking privilege comprises a list of privilege codes of system functions allowed to be used by the web page; and
If the browser determines that the privilege code of the system function requested to be invoked belongs to the list of privilege codes in the system function invoking privilege, then invoking the system function requested to be invoked through an interface function of the corresponding system function to support running of the web page; if the browser determines that the privilege code of the system function requested to be invoked does not belong to the list of privilege codes in the system function invoking privilege, prohibiting invoking of the interface function of the system function requested to be invoked.

12. The storage medium of claim 11, wherein the authorization code comprises at least an identifier of the web page; and
obtaining, by the browser, the system function invoking privilege corresponding to the web page according to the authorization code comprises:
determining whether there is a system function invoking privilege corresponding to the obtained authorization code, according to a correspondence relationship in a memory of the intelligent device, between the authorization code and the system function invoking privilege, and if there is the system function invoking privilege corresponding to the obtained authorization code, then obtaining the system function invoking privilege corresponding to the authorization code, and determining the obtained system function invoking privilege as the system function invoking privilege corresponding to the web page; and
If there is no system function invoking privilege corresponding to the obtained authorization code, then transmitting, by the browser, the authorization code to a cloud server, and obtaining and returning, by the cloud server, to the browser the system function invoking privilege corresponding to the authorization code according to the authorization code, and receiving, by the browser, the system function invoking privilege returned by the cloud server, determining the received system function invoking privilege as the system function invoking privilege corresponding to the web page, and storing the system function invoking privilege in the memory of the intelligent device.

13. The storage medium of claim 12, wherein the authorization code further comprise a system function invoking privilege corresponding to the web page; and
after the browser transmits the authorization code to the cloud server, the method further comprises:
if the browser does not receive the system function invoking privilege returned by the cloud server in a preset length of time, then parsing the authorization code to obtain the system function invoking privilege carried in the authorization code, and determining the obtained system function invoking privilege as the system function invoking privilege corresponding to the web page.

14. The storage medium of claim 12, wherein the authorization code further comprises information about the web page; and
before the browser receives the system function invoking privilege returned by the cloud server, the cloud server obtains and returns to the browser the system function invoking privilege corresponding to the authorization code according to the authorization code upon determining that the information about the web page carried in the authorization code is same as locally stored information about the web page corresponding to the identifier of the web page.

15. The storage medium of claim 11, wherein the authorization code in the web page and the system function invoking privilege corresponding to the web page are generated by a cloud server according to information about the web page.
